(19) United States
(12) Patent Application Publication
(10) Pub. No.: US 2007/0050714 A1
(43) Pub. Date: Mar. 1, 2007

(54) Host device and data management method thereof

(75) Inventor: Hyung-jong Kang, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/489,585

(22) Filed: Jul. 20, 2006

(30) Foreign Application Priority Data
Aug. 29, 2005 (KR) 2005-79681

(51) Int. Cl. G06F 17/00

(52) U.S. Cl. 715/700; 715/517

(57) ABSTRACT

A host device utilizing a data management method includes: a storage unit storing at least one data; a data management program unit arranging the data stored in the storage unit according to a predetermined criterion to create index information, and creating a user interface, which includes an index information display area on which the index information is displayed, and a work area on which a predetermined work is performed on the data; and a display interface transmitting the user interface to a display apparatus. Therefore, efficient data management is possible.

### CROSS-REFERENCE TO RELATED APPLICATION

This application claims the benefit under 35 U.S.C. §119 from Korean Patent Application No. 2005-79681, filed on Aug. 29, 2005 in the Korean Intellectual Property Office, the disclosure of which is incorporated herein by reference.

### BACKGROUND OF THE INVENTION

1. Field of the Invention

Aspects of the present invention relate to a host device and a data management method thereof, and more particularly to a host device which is capable of displaying a work area and an index information display area on the same window, and a data management method thereof.

2. Description of the Related Art

As the use of computers has become widespread, various documents, which have conventionally been manually written, are being created using application programs, such as word processors, and other like programs. The various documents are stored and managed in computers and other storage media in file units. Also, images such as pictures, other than such various documents, are managed in filed units.

Recently, as application programs for creating documents on a computer become more varied according to their use purposes, even more documents are being created using computers. Accordingly, the types of documents to be managed by a computer are diversified and the number of the documents greatly increases. In order to meet this trend, operating systems installed in computers provide a Window Searcher for managing a large amount of files. The Window Searcher allows users to create or erase folders and thus manage files in units of folders. The Window Searcher also provides a search function for searching for a desired file when users do not know the location of the file in the folders.

Since most Window Searchers recognize the contents of a file through its file name, a document management program for providing the contents of a file in the format of a “preview” and allowing simple manipulations on the file has been proposed. The conventional document management program provides a search function for allowing a user to search for desired files from a plurality of files, and a control function for providing the contents of files included in a folder selected by a user in the format of “preview” and allowing simple manipulations on the files. The search function and the control function are independently implemented through separate windows. Users can execute functions of file movement, file copy, etc., through the windows which provides the search function and the control function.

However, in the conventional document management program, since the search function and the control function (even though these functions have a high relationship) are provided through separate windows, beginners have difficulties in properly arranging files, resulting in low use efficiency.

### SUMMARY OF THE INVENTION

A feature of the present invention is to provide a host device, which is capable of managing data through a user interface, which includes both an index information display area for the data and a work area on which a work is actually performed, on the same window, and a data management method thereof.

According to an embodiment of the present invention, a host device includes a storage unit storing at least one data; a data management program unit arranging the data stored in the storage unit according to a predetermined criterion to create index information, and creating a user interface, which includes an index information display area on which the index information is displayed, and a work area on which a predetermined work is performed on the data; and a display interface transmitting the user interface to a display apparatus.

According to an embodiment of the present invention, the data management program unit manages the data according to a work selected by a user through the user interface.

According to an embodiment of the present invention, the index information is one of a date and a type of the data.

According to an embodiment of the present invention, the user interface further includes a detailed list display area on which a detailed list regarding the index information is displayed, and a data display area on which data corresponding to a detailed item selected from the detailed list is displayed.

According to an embodiment of the present invention, the data display area displays the data corresponding to the detailed list in one format of Thumbnail, Overview, or Detailed View.

According to an embodiment of the present invention, the user interface further includes a data search area on which the data stored in the storage unit is displayed in a tree structure.

According to an embodiment of the present invention, the predetermined work which can be performed in the work area includes data copy, data movement, data binding, data unbinding, and annotation.

In order to achieve another feature of the present invention, a data management method of a host device including a storage unit includes arranging at least one data stored in the storage unit according to a predetermined criterion and creating index information; creating a user interface, which includes an index information display area on which the index information is displayed, and a work area on which a predetermined work is performed on the data; transmitting the user interface to a display apparatus and displaying the user interface on the display apparatus; and managing the data according to a work selected by a user through the work area of the user interface.

According to an embodiment of the present invention, the index information is one of a date and a type of the data.

According to an embodiment of the present invention, the user interface further includes a detailed list display area on which a detailed list regarding the index information is displayed, and a data display area on which data corresponding to a detailed item selected from the detailed list is displayed.

According to an embodiment of the present invention the data corresponding to the detailed item is displayed in the data display area in the format of Thumbnail, Overview, and/or Detailed View.

According to an embodiment of the present invention, the user interface further includes a data search area on which the data stored in the storage unit is displayed in a tree structure.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects and features of the present invention will be more apparent and more readily appreciated by describing certain embodiments of the present invention with reference to the accompanying drawings, in which:

FIG. 1 is a block diagram of a host device according to an embodiment of the present invention;

FIG. 2 illustrates an example of a user interface provided by a data management program unit illustrated in FIG. 1; and

FIG. 3 is a flowchart illustrating a data management method of the host device, according to an embodiment of the present invention.

### DETAILED DESCRIPTION OF THE EMBODIMENTS

Certain embodiments of the present invention will be described in greater detail with reference to the accompanying drawings, wherein like reference numerals refer to the like elements throughout. The embodiments are described below in order to explain the present invention by referring to the figures.

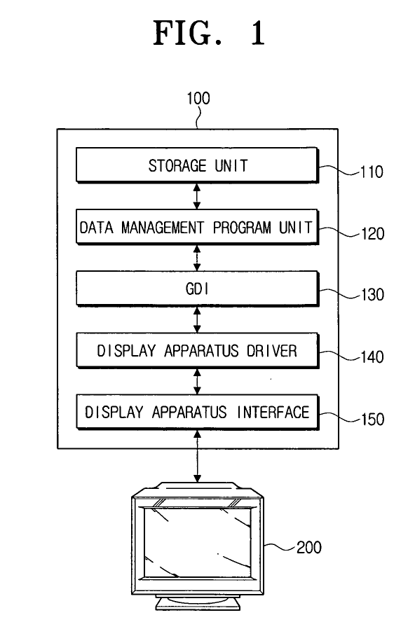

FIG. 1 is a block diagram of a host device 100 according to an embodiment of the present invention. Referring to FIG. 1, the host device 100 includes a storage unit 110, a data management program unit 120, a Graphic Device Interface (GDI) 130, a display apparatus driver 140, and a display apparatus interface 150. The host device 100 is connected to a display apparatus 200 by a predetermined connection method. The connection can be by a wired and/or wireless connection according to aspects of the invention. Additionally, while shown as separate, it is understood that the display apparatus 200 can include the host device 100, such as in a tablet PC, a personal digital assistant, and/or a multimedia player.

The storage unit 110 stores at least one data. Data is stored in the storage unit 110 in units of a file. The data stored in the file units can be classified and stored in folders or directories, but need not in all aspects of the invention. Preferably, the storage unit 110 is a Hard Disk Driver (HDD), but can be other types of media such as flash memory, optical media, magnetic media, magneto-optical media and other like storage devices. Moreover, while shown as part of the host device 100, it is understood that the storage unit 110 can be connected as an external drive or across a network accessible by the host device 100.

The data management program unit 120 is an application program which provides a user interface including both an index information display area for the data and a work area on which work is actually performed. This user interface allows users to easily manage the data stored in the host device 100 according to a work selected by the user through the user interface. The data management program unit 120 extracts the data stored in the storage unit 110 and arranges the extracted data according to a predetermined criterion, thus creating index information. By way of example, the index information may be any one of date and/or data type. However, it is understood that the index may be otherwise, such as alphabetical by file name, creator, owner, or other like criterion.

After the data management program unit 120 creates the index information, the data management program unit 120 creates a user interface (UI), including an index information display area on which the index information is displayed, and a work area on which a predetermined work is performed on the data. The work which can be performed in the work area may be data binding of files or pages within a larger file or organization of linked files, data unbinding to split files or pages from a larger file or organization of linked files, data rotating to change orientations of pages in the file, and annotation, or other work in which the files are manipulated, reorganized and/or linked.

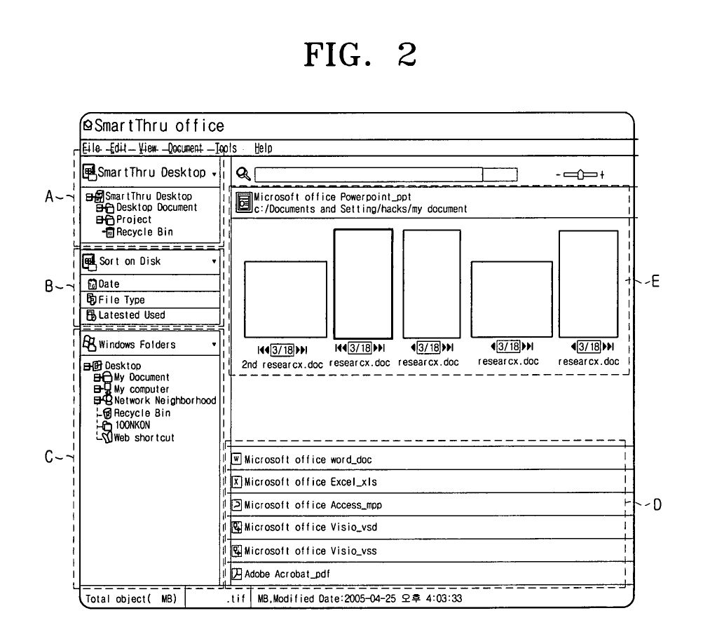

While not required, it is understood that the user interface created by the data management program unit 120 can further include a detailed list display area on which details regarding the index information are displayed, and a data display area on which data corresponding to a detailed item selected by a user from the details is displayed. Here, the data corresponding to the detailed item selected by the user may be displayed in the format of “Thumbnail”, “Overview”, and/or “Detailed View” on the data display area or combinations thereof such as tiles. Also, the user interface created by the data management program unit 120 can further include a data search area on which the data stored in the storage unit 110 is represented in a tree structure. An example of the user interface, which is created by the data management program unit 120, displayed through the display apparatus 200, and provided to the user, will be described in more detail below with reference to FIG. 2.

The GDI 130 is a MICROSOFT WINDOWS operating system used as a computer operating system, and supports interface between the data management program unit 120 and the display apparatus driver 140. For example, the GDI 130 transfers display object data transmitted from the data management program unit 120 to the display apparatus driver 140. Here, the display object data may be the user interface created by the data management program unit 120. While described as a GDI used in a WINDOWS operating system, it is understood that any program or standard used to represent graphical objects to be transmitted to a display can be used in a WINDOWS or other operating system.

The display apparatus driver 140 transforms the display object data (that is, the user interface) received from the GDI 130 into a data format which can be displayed on the display apparatus 200. The display apparatus interface 150 can be connected to the display apparatus 200 to support interface between the host device 100 and the display apparatus 200. For example, the user interface transformed into a displayable data format by the display apparatus driver 140, is transmitted to the display apparatus 200 through the display apparatus interface 150. The display apparatus 200 displays the display object data received from the host device 100. For example, the display apparatus 200 displays the user interface received from the host device 100 to provide the interface to the user. However, it is understood that the interface 150 need not be used in all aspects.

FIG. 2 illustrates an example of a user interface provided by the data management program unit 120 illustrated in FIG. 1. Referring to FIGS. 1 and 2, the user interface is created by the data management program unit 120 of the host device 100, transmitted to the display apparatus 200 through the GDI 130, the display apparatus driver 140, and the display apparatus interface 150, and provided to a user. The user interface includes a work area A, an index information display area B, a data search area C, a detailed list display area D, and a data display area E. Also, the user interface includes menus (such as “File”, “Edit”, “View”, Document”, Tools”, and “Help”) for providing various functions, but, a detailed description regarding these menus is omitted as being known to one of ordinary skill in the art. It is understood that the menus can be otherwise constructed, and need not be used in all aspects of the invention.

In the work area A, at least one folder is created in a tree structure according to a user's selection. In the work area A, a predetermined work, such as grouping files in different folders, renaming files and/or folders, data binding, data unbinding, annotation, file erasure, etc., can be performed by user's manipulation. In this manner, the user can organize the data in virtual folders and drawers according to a user's needs, such as by “Project” as shown.

In the index information display area B, index information is sequentially displayed. The index information is obtained for example, by arranging data stored in the storage unit 110 according to a predetermined criterion. In the current embodiment, the index information includes “Date”, “File Type”, and “Last Used”. If the user selects “Date”, date information of the data can be sequentially displayed on the detailed list display area D. However, other index information can be used, such as by location of the file on other storage media, creator of the file, or other like information.

The data search area C provides functions similar to a conventional Window Searcher, and the data stored in the storage unit 110 is displayed in a tree structure on the data search area C. In the data search area C, simple works (such as data copy and data movement) can be performed. As shown, the files are organized in a hierarchy of folders and subfolders prepared by the operating system of the host 100 (i.e., the Windows Explorer of MICROSOFT WINDOWS), but without allowing more complex works to be performed such as data binding and unbinding of files from disparate folders. However, it is understood that the data search area C could also allow more complex works such as binding and unbinding in other aspects of the invention.

In the detailed list display area D, a detailed list regarding index information selected by the user from the index information displayed in the index information display area B is displayed. For the example shown, the user selected “File Type” in the index information display area B, data types, such as Word document, Excel document, etc., are displayed on the detailed list display area D.

In the data display area E, data corresponding to a detailed item selected by the user from the detailed list displayed on the detailed list display area D is displayed in a format, such as “Thumbnail”, “Overview”, “Detailed View” or combinations thereof. While not required, as illustrated in FIG. 2, the data is displayed in the format of “Thumbnail” with data names displayed on the lower part of the data display area E. In this manner, files can be located using areas B, C, D, and/or E, and then worked on (e.g., bound into a larger object without disturbing the original file structure) in area A within a larger display window organization.

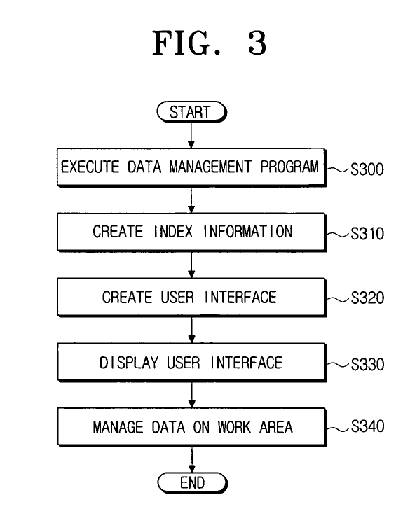

FIG. 3 is a flowchart illustrating a data management method of the host device 100, according to an embodiment of the present invention. Hereinafter, the data management method of the host device 100 will be described with reference to FIGS. 1, 2, and 3. While not required in all aspects, it is understood that elements of the method can be implemented using one or more computer readable medium to be implemented on one or more computers.

When a user wants to easily manage data stored in the storage unit 110 of the host device 100, the user executes the data management program unit 120 (operation S300). The data management program unit 120 arranges the data stored in the storage unit 110 according to a predetermined criterion (for example, according to data type or date), and creates the index information (operation S310). After creating the index information, the data management program unit 120 creates a user interface, including an index information display area B on which the index information is displayed, and a work area A on which a work can be actually performed on the data (operation S320). While not required, the index information can be previously indexed information or a combination of previously and newly created index information.

The user interface created by the data management program unit 120 is transferred to the display apparatus driver 140 through the GDI 130, and the display apparatus driver 140 transforms the user interface into a displayable format. The resultant user interface is transmitted to the display apparatus 200 through the display apparatus interface 150 and displayed on the display apparatus 200 (operation S330).

When the user recognizes the user interface created by the data management program unit 120 through the display apparatus 200, the user can perform a predetermined work in the work area A to manage the data stored in the storage unit 110 (operation S340). While not required, data transformed by user's manipulation in the work area A of the user interface is stored in the storage unit 110. The process from operation S300 is repeated whenever the data management program unit 120 is executed by a user.

As described above, in a host device and a data management method thereof, according to aspects of the present invention, by providing an integrated navigation user interface allowing user browsing, in which an index information display area on which data stored in the host device is indexed and a work area on which a work is actually performed on the data are displayed on the same window, users can easily perform data management through simple manipulation.

The foregoing embodiments and/or advantages are merely exemplary and are not to be construed as limiting the present invention as set forth in the accompanying claims and equivalents thereof. The present teaching can be readily applied to other types of embodiments. Also, the description of the embodiments of the present invention is intended to be illustrative, and not to limit the scope of the claims, and many alternatives, modifications, and variations will be apparent to those skilled in the art.

What is claimed is:

1. A data management method of a host device including a storage unit, comprising:
arranging at least one data stored in the storage unit according to a predetermined criterion and creating index information;
creating a user interface, which comprises an index information display area on which the index information is displayed, and a work area on which a predetermined work is performed on the data;
transmitting the user interface to a display apparatus and displaying the user interface on the display apparatus; and
managing the data according to a work selected by a user through the work area of the user interface.

2. The data management method of claim 1, wherein the index information is by a date and/or a type of the data.

3. The data management method of claim 1, wherein the user interface further comprises a detailed list display area on which a detailed list regarding the index information is displayed, and a data display area on which data corresponding to a detailed item selected from the detailed list is displayed.

4. The data management method of claim 3, wherein in the data display area, the data corresponding to the detailed item is displayed in a Thumbnail format, an Overview format, or a Detailed View format.

5. The data management method of claim 1, wherein the user interface further comprises a data search area on which the data stored in the storage unit is displayed in a tree structure.

6. The data management method of claim 1, wherein the storage unit is a Hard Disk Driver (HDD) and/or an external storage medium.

7. A host device comprising:
a data management program unit to create a user interface comprising an index information display area and a work area other than the index information display area, to display in the index information display area an index of stored data according to properties of the stored data, and to display in the work area a data management structure in which document management is performed on the stored data while the index is displayed; and
a display controller to control the user interface to be displayed on a display apparatus.

8. The host device of claim 7, wherein the data management program unit further manages the stored data in the data management structure by binding and unbinding the stored data according to a user selection.

9. The host device of claim 7, wherein the data management program unit further:
creates in the user interface a data display area other than the index information display area and the work area, and
displays on the data display area items of data selected using the index information in the index information area.

10. The host device of claim 9, wherein the data management program unit creates in the user interface a data search area and displays the data as stored in a storage unit in a tree structure within the data search area.

11. The host device of claim 10, wherein the management performed in the work area is selectable between data copy, data movement, data binding, data unbinding, and annotation.

12. The host device of claim 7, wherein the management performed in the work areas is selectable between data binding, data unbinding, and annotation.

13. The host device of claim 7, wherein the data management program unit further creates in the user interface a data search area other than the index information display area and the work area, and displays the data as stored in a storage unit in a tree structure.

14. The host device of claim 13, wherein the tree structure organizes the stored data other than as organized in the displayed index and in the displayed data management structure.

15. The host device of claim 13, wherein the tree structure reflects storage of the data in file units within folders in an organization created by an operating system of the host device, and the displayed index and the displayed data management structure are independent of the tree structure.

16. The host device of claim 7, wherein the data are stored within an organization created by an operating system of the host device, and the displayed index and the displayed data management structure are independent of the organization of the operating system.

17. The host device of claim 7, wherein the data management program unit further receives an index selection selecting one of a plurality of properties according to which the stored data can be indexed by the data management program unit, and re-indexes the stored data displayed in the index information area according to the one of the properties indicated by the received index selection.

18. A data management method of a host device, comprising:
indexing data stored in a storage unit according to a criterion;
creating a user interface on which an index information display area displays the indexed data and a work area showing a data management framework within which data management is performed on the data; and
managing the data within the data management framework according to a selection by a user through the work area of the user interface.

19. The method of claim 18, wherein the managing the data comprises performing data binding on the data through the work area.

20. The method of claim 19, wherein the indexing the data comprises receiving an index selection selectable between a plurality of criterion, and indexing the data according to the selected criterion indicated by the index selection.

21. The method of claim 20, wherein the plurality of criterion include file type, a creation date, and a last used date.

22. A computer readable medium encoded with processing instructions for implementing a method of 18 performed by one or more computers.
